(19) United States
(12) Patent Application Publication
(10) Pub. No.: US 2003/0133480 A1
(43) Pub. Date: Jul. 17, 2003

(54) Semiconductor laser module

(76) Inventor: Hiroyasu Torazawa, Tokyo (JP)

Correspondence Address: VOLENTINE FRANCOS, PLLC, Suite 150, 12200 Sunrise Vally Drive, Reston, VA, 20191, US

(21) Appl. No.: 10/254,986

(22) Filed: Sep. 26, 2002

(30) Foreign Application Priority Data
Jan. 11, 2002 (JP) 004432/2002

(51) Int. Cl. H01S 3/13; H01S 3/04

(52) U.S. Cl. 372/36; 372/32

(57) ABSTRACT

Light emitted backward from a semiconductor laser device 1 is brought into parallel light by a lens 2, followed by passing through a filter 31. The filter 31 varies in transmittance depending on the wavelength of incident light and includes a wavelength selection region 316 having a wavelength selective function and a through hole 310 defined within the wavelength selection region. Each of light-receiving elements 4 and 5 has a photoelectric transfer function and generates a photocurrent corresponding to the accepted amount of light. The light transmitted through the wavelength selection region 316 other than the through hole 310 of the filter 31 is launched into the light-receiving element 4, and the light transmitted through the through hole 310 is launched into the light-receiving element 5. A variation in the wavelength of the light emitted from the semiconductor laser device 1 and a variation in optical output thereof are respectively detected by monitoring the amounts of photocurrents produced in the light-receiving elements 4 and 5.

### BACKGROUND OF THE INVENTION

The present invention relates to a semiconductor laser module having the function of controlling the wavelength of outgoing laser light.

A semiconductor laser module comprises a semiconductor laser device, a light-receiving element, an element for temperature control, etc. which have been mounted within a package. The semiconductor laser device is of a main device of the semiconductor laser module and emits laser light having a predetermined wavelength with the application of a current. The wavelength of the laser light varies with self-heating, a variation in ambient temperature, etc. Further, the output of the laser light varies with a variation in drive source, a temperature variation due to self-heating or the like, etc. Thus, the wavelength of the laser light emitted from the semiconductor laser device and its optical output highly depend on the temperature. To this end, in general, part of laser light is launched into a light-receiving element, and the temperature is controlled using a temperature control element while the output of the light-receiving element is being monitored, whereby the wavelength of the laser light and its optical output are controlled.

A technology related to a wavelength stabilizing laser module has been disclosed in, for example, Japanese Patent Application Laid-Open No. 2001-257419. This relates to a laser module wherein potential signals produced from both a first photoelectric transfer element into which part of light emitted from a semiconductor laser is launched, and a second photoelectric transfer element into which part of the light emitted from the semiconductor laser is launched after having passed through a wavelength dependent filter, are fed back to the semiconductor laser and/or temperature adjusting means, whereby a reference wavelength laser light is stably outputted.

FIG. 1 is a cut-out perspective view of a conventional semiconductor laser module, and FIG. 2 is a configurational view thereof, respectively. The semiconductor laser module includes a semiconductor laser device 1, a lens 2, a filter 3, a light-receiving element 4, a light-receiving element 5, a thermistor element 7 and a lens 8. They are mounted on a sub-board 9. The sub-board 9 is placed on a peltier element 10. The parts referred to above are mounted inside a package 11 made up of a metal. An isolator 12 and an optical fiber 13 are coupled to the package 11.

The filter 3 has a wavelength selectivity and varies in transmittance depending on the wavelength of incident light. An etalon element or the like is used for the filter 3. In general, the etalon element has a pair of parallel planes surface-ground with high accuracy. Owing to the utilization of the interference of light at the planes, the etalon element has a wavelength selectivity. A dielectric multilayer film is normally evaporated onto the planes to form the etalon element.

The semiconductor laser device 1 emits laser light having a predetermined wavelength forward and backward with a spread angle. The backward-emitted light is converted into parallel light having a predetermined luminous flux diameter by the lens 2. Part of the parallel light passes through the filter 3 and thereafter falls on the light-receiving element 4. The remaining part of the parallel light is launched into the light-receiving element 5 as it is. Each of the light-receiving element 4 and the light-receiving element 5 includes a photoelectric transfer function and outputs an optical current or photocurrent having an optical current amount corresponding to the accepted amount of light. The forward-emitted light is converged by the lens 8 and launched into the optical fiber via the isolator 12 with a lens. The isolator 12 is used to eliminate the influence of reflection of the laser light. The temperature is controlled by the thermistor element 7 and the peltier element 10. Incidentally, FIG. 2 shows the entrance of the forward-emitted light into the lens 8.

Variations in the optical output of the laser light emitted from the semiconductor laser element 1 appear on the forward-emitted light and the backward-emitted light similarly. When the oscillated wavelength of the laser light emitted from the semiconductor laser device 1 varies, the amount of the light transmitted through the filter 3 varies, and the amount of the light received by the light-receiving element 4 varies. This appears as a variation in the amount of a photocurrent outputted by the light-receiving element 4. When the optical output of the laser light emitted from the semiconductor laser device 1 varies, the amount of the light received by the light-receiving element 5 varies, and hence it appears as a variation in the amount of a photocurrent outputted by the light-receiving element 5. Namely, the light-receiving element 4 serves as an oscillated wavelength control monitor, whereas the light-receiving element 5 serves as an optical output control monitor. The temperature is controlled by the thermistor element 7 and the peltier element 10 while monitoring the variations in the amounts of the photocurrents of the light-receiving elements 4 and 5, whereby the oscillated wavelength and optical output of the semiconductor laser device 1 are respectively controlled so as to take a constant value. Thus, the present module controls not only the optical output but also the wavelength and has a wavelength lock function.

Since, however, the etalon element causes damage to the periphery of a device during a manufacturing process, about 20% of the device periphery obtains no wavelength selective function. An etalon element having a size enough for an incident surface is needed to allow all the luminous fluxes incident to the light-receiving element 4 to pass through a wavelength selection region having a wavelength selective function of the etalon element. In the example shown in FIGS. 1 and 2, the luminous flux transmitted through the etalon element and the luminous flux non-transmitted through the etalon element are respectively launched into the light-receiving elements 4 and 5. In order to form such two types of luminous fluxes, parallel light emitted from the lens 2 needs to have a luminous flux diameter having a sufficient size. From the above viewpoint, the related art example is accompanied by a problem that a mounting space increases.

### SUMMARY OF THE INVENTION

The present invention may provide a semiconductor laser module capable of being configured in compact form.

Light emitted backward from a semiconductor laser device is brought into parallel light by a lens, followed by passing through a filter. The filter varies in transmittance depending on the wavelength of incident light and includes a wavelength selection region having a wavelength selective function and a through hole defined within the wavelength selection region. Each of light-receiving elements has a photoelectric transfer function and generates a photocurrent corresponding to the accepted amount of light. The light transmitted through the wavelength selection region other than the through hole of the filter is launched into the light-receiving element, and the light transmitted through the through hole is launched into the light-receiving element. A variation in the wavelength of the light emitted from the semiconductor laser device and a variation in optical output thereof are respectively detected by monitoring the amounts of photocurrents produced in the light-receiving elements.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a cut-out perspective view showing a conventional semiconductor laser module;

FIG. 2 is a configurational view illustrating the conventional semiconductor laser module;

FIG. 3 is a configurational view depicting a semiconductor laser module according to a first embodiment of the present invention;

FIG. 4 is a perspective view showing a schematic configuration of a filter according to the first embodiment of the present invention;

FIG. 5 is a configurational view illustrating a semiconductor laser module according to a second embodiment of the present invention;

FIG. 6 is a perspective view depicting a schematic configuration of a filter according to the second embodiment of the present invention;

FIG. 7 is a configurational view showing a semiconductor laser module according to a third embodiment of the present invention; and

FIG. 8 is a perspective view illustrating a schematic configuration of a filter according to the third embodiment of the present invention.

### DETAILED DESCRIPTION OF THE PREFERRED EMBODIMENTS

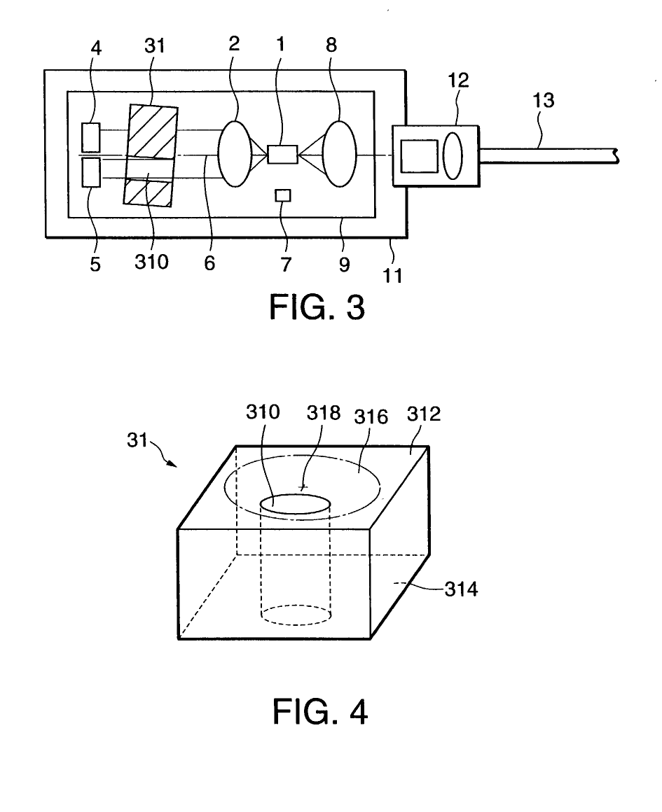

Preferred embodiments of the present invention will hereinafter be described in detail with reference to the accompanying drawings. Incidentally, elements of structure each having substantially the same function and configuration are respectively identified by the same reference numerals in the following description and the accompanying drawings, and the description of common elements of structure will therefore be omitted. FIG. 3 is a configurational view showing a semiconductor laser module according to a first embodiment of the present invention.

The semiconductor laser module has a semiconductor laser device 1, a lens 2, a filter 31, a light-receiving element 4, a light-receiving element 5, a thermistor element 7, and a lens 8. These are mounted on a sub-board 9. The sub-board 9 is placed on a peltier element (not shown). The parts referred to above are mounted inside a package 11 made up of a metal. An isolator 12 and an optical fiber 13 are coupled to the package 11. The semiconductor laser device 1, light-receiving element 4, light-receiving element 5, thermistor element 7 and peltier element are respectively wire-connected to their corresponding terminals of the package 11 with gold wires or the like.

The semiconductor laser device 1 is of a main device of the present module. The semiconductor laser device 1 oscillates with a predetermined wavelength in response to the application of a current and radiate laser light having such an oscillated wavelength forward and backward with a predetermined spread angle. The forward-radiated light is handled as light outputted from the present module. The backward-radiated light is used for monitoring the oscillated wavelength and optical output.

The lens 2 is used to set light emitted from the semiconductor laser device 1 as parallel light. The filter 31 includes a through hole 310 and includes a predetermined wavelength selectivity. Further, the filter 31 varies in transmittance depending on the wavelength of incident light. The filter 31 comprises an etalon element in the present embodiment. In general, the etalon element has a pair of parallel planes surface-ground with high accuracy. Owing to the utilization of the interference of light at the planes, the etalon element has a wavelength selectivity. Described specifically, for example, the etalon element is formed by evaporating a dielectric multilayer film onto the surface-grounded surface and back of parallel plate quartz glass with the quartz glass as a material.

FIG. 4 shows a schematic configuration of the filter 31. The filter 31 has an upper surface 312 and a lower surface 314 both shown in FIG. 4 as a light-incoming surface and a light-outgoing surface. A dielectric multilayer film is deposited on these two surfaces. The filter 31 has a through hole 310 having a cross-section extending therethrough from the upper surface 312 to the lower surface 314, which is substantially circular. An outer peripheral portion of the filter 31 has no wavelength selective function due to damage produced during a manufacturing process. In FIG. 4, a wavelength selection region 316 having a predetermined wavelength selective function is shown on the upper surface 312 of the filter 31. Namely, the predetermined wavelength selectivity of the filter 31 is effective only for light transmitted through the wavelength selection region 316. The through hole 310 is provided within the wavelength selection region 316. An opening defined in the upper surface 312, of the through hole 310 is placed in a position shifted from the center 318 of the filter 31.

The light-receiving element 4 and the light-receiving element 5 respectively have photoelectric transfer functions and output photocurrents each having the amount of the photocurrent corresponding to the accepted amount of light. The thermistor element 7 and the peltier element are used for temperature control. Since the components or constituent parts such as the semiconductor laser device 1, etc. are mounted on the peltier element with the sub-board 9 interposed therebetween, these constituent parts are equally placed under temperature control by the peltier element. The lens 8 has the function of converging light emitted from the semiconductor laser device 1 and efficiently allowing the converged light to enter the optical fiber 13. The isolator 12 is used to eliminate the influence of reflection of the laser light. The isolator 12 is equipped with a lens in the present embodiment.

As shown in FIG. 3, the lens 8, the isolator 12 and the optical fiber 13 are disposed in turn on an optical path ahead of the semiconductor laser device 1 along an optical axis 6. The lens 2, the filter 31, the light-receiving element 4 and the light-receiving element 5 are disposed on an optical path at the rear of the semiconductor laser device 1. The filter 31 is disposed with being slightly inclined to the optical axis 6 in such a manner that light reflected from the surface of the filter 31 is not launched into the semiconductor laser device 1. In order to aid the understanding of the filter 31 shown in FIG. 3, the filter 31 includes the center 318 and the through hole 310. Further, a cross-section orthogonal to the upper surface 312 is shown and portions other than the through hole 310 of the filter 31 are diagonally shaded. The light-receiving element 4 and the light-receiving element 5 are disposed in parallel within a plane orthogonal to the optical axis 6 such that the optical axis 6 is located therebetween. The light-receiving element 4 is disposed in such a manner that light transmitted through the wavelength selection region 316 other than the through hole 310 of the filter 31 is launched therein. Further, the light-receiving element 5 is placed such that light transmitted through the through hole 310 of the filter 31 is launched therein.

The light, which is radiated backward from the semiconductor laser device 1 with a spread angle, is converted into parallel light by the lens 2, followed by passing through the filter 31. A size to satisfy the wavelength selection region 316 of the filter 31 is enough for a luminous flux diameter of such parallel light. It is not necessary to increase the diameter to more than its size. Of the light transmitted through the filter 31, part of the-light transmitted through the wavelength selection region 316 other than the through hole 310 is launched into the light-receiving element 4. Of the light transmitted through the filter 31, some or all of the light transmitted through the through hole 310 are launched into the light-receiving element 5. Incidentally, the luminous flux diameter of the parallel light can also be set smaller than the wavelength selection region 316 according to the sizes of light-receiving surfaces of the light-receiving element 4 and the light-receiving element 5.

When the wavelength of the laser light emitted from the semiconductor laser device 1 varies, the amount of light transmitted through the wavelength selection region 316 varies based on wavelength dependency of the filter 31, and the amount of the light received by the light-receiving element 4 varies. Hence the amount of a photocurrent produced in the light-receiving element 4 varies. Thus, the monitoring of the amount of the photocurrent of the light-receiving element 4 allows detection of a variation in wavelength.

When the optical output emitted from the semiconductor laser device 1 varies, the amount of the light transmitted through the through hole 310 and received by the light-receiving element 5 varies, and hence the amount of a photocurrent produced in the light-receiving element 5 varies. Thus, the monitoring of the amount of the photocurrent of the light-receiving element 5 enables detection of a variation in optical output.

As described above, the light emitted from the semiconductor laser device 1 varies in wavelength and optical output due to a temperature variation. The temperature is controlled under the thermistor element 7 and the peltier element while monitoring the amounts of the photocurrents from the light-receiving element 4 and the light-receiving element 5, thereby making it possible to control the wavelength of the light emitted from the semiconductor laser device 1 and its optical output. As described above, the present module controls not only the optical output but also the wavelength and has a wavelength lock function.

The light forward from the semiconductor laser device 1 is converted by the lens 8 and launched into the optical fiber 13 via the isolator 12, from which the converged light is outputted. Incidentally, FIG. 3 shows the entrance of the forward-emitted light to the lens 8.

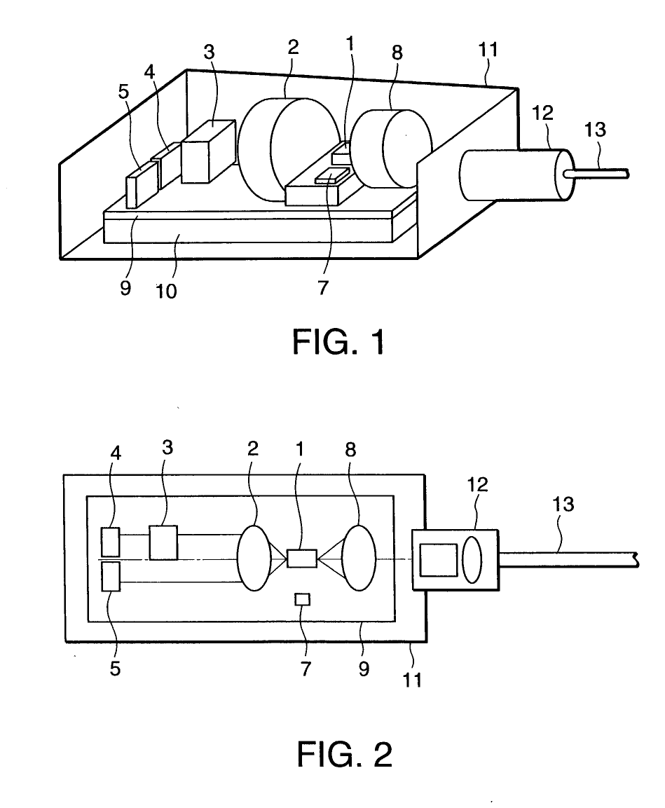

According to the present embodiment as described above, both the wavelength of the light emitted from the semiconductor laser device 1 and its optical output can be controlled by the luminous flux launched into the wavelength selection region 316 owing to the definition of the through hole 310 within the wavelength selection region 316 of the filter 31. In the related art, the luminous flux transmitted through the etalon element and the luminous flux non-transmitted therethrough have respectively been launched into the light-receiving element 4 and the light-receiving element 5 as shown in FIG. 1. Since the luminous flux transmitted through other than the wavelength selection region of the etalon element has been in existence, a large parallel luminous flux was needed. According to the present embodiment, however, since the wavelength selection region 316 may be satisfied even if the diameter of the parallel luminous flux outputted via the lens 2 is of the maximum, the diameter of the parallel luminous flux can be reduced as compared with the conventional one. It is thus possible to reduce a mounting space to a large extent and construct the module in compact form.

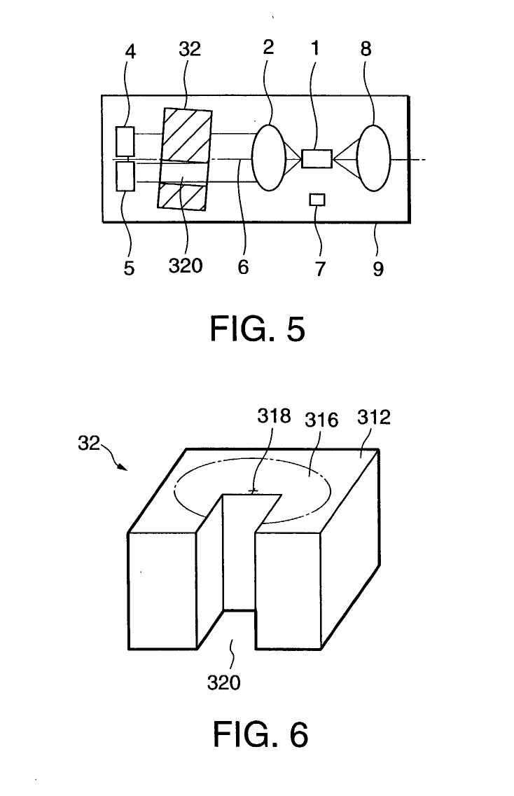

FIG. 5 is a fragmentary configurational view showing a semiconductor laser module according to a second embodiment of the present invention. In the present embodiment, a filter 32 having a cut-away portion 320 is used as an alternative to the filter 31 employed in the first embodiment. Since other elements of structure are similar to those employed in the first embodiment, the description of certain common elements will partly be omitted. Only principal constituent parts on a sub-board 9 are illustrated in FIG. 5, and a package 11, an isolator 12 and an optical fiber 13 are not shown in the drawing.

FIG. 6 shows a schematic configuration of the filter 32. The filter 32 comprises an etalon element and has a cut-away portion 320. Further, the filter 32 has a predetermined wavelength selectivity and varies in transmittance depending on the wavelength of incident light. The filter 32 has an upper surface 312 shown in FIG. 6 and a lower surface used as a surface opposite thereto, as a light-incoming surface and a light-outgoing surface. A dielectric multilayer film is grown on these two surfaces. A peripheral portion of the filter 32 has no wavelength selective function due to damage produced during a manufacturing process. In FIG. 6, a region having a predetermined wavelength selective function is shown on the upper surface 312 of the filter 32 as a wavelength selection region 316. The cut-away portion 320 is formed so as to extend from the upper surface 312 to the lower surface and has such a form that a rectangular parallelepiped is cut from the center of one side of the filer 32. As a result, the shape of the filter 32 as viewed from above the upper surface 312 results in a substantially inverted U shape. Part of the rectangular parallelepiped is located within the wavelength selection region 316 and part of the cut-away portion 320 is formed within the wavelength selection region 316.

As shown in FIG. 5, the lens 8, the isolator 12 and the optical fiber 13 are disposed in order ahead of the semiconductor laser device 1 along an optical axis 6. The lens 2, filter 32, light-receiving element 4 and light-receiving element 5 are placed rearwardly of the semiconductor laser device 1. The filter 32 is disposed with being slightly inclined to the optical axis 6 in such a manner that light reflected from the surface of the filter 32 is not launched into the semiconductor laser device 1. In order to aid the understanding of the filter 32 shown in FIG. 5, the filter 32 includes the center 318 and the cut-away portion 320. Further, a cross-section orthogonal to the upper surface 312 is shown in the filter 32, and portions other than the cut-away portion 320 of the filter 32 are diagonally shaded. The light-receiving element 4 and the light-receiving element 5 are disposed in parallel within a plane orthogonal to the optical axis 6 such that the optical axis 6 is located therebetween. The light-receiving element 4 is disposed in such a manner that light transmitted through the wavelength selection region 316 other than the cut-away portion 320 of the filter 32 is launched therein. Further, the light-receiving element 5 is placed such that light transmitted through the cut-away portion 320 of the filter 32 is launched therein.

The light radiated backward from the semiconductor laser device 1 with a spread angle is converted into parallel light by the lens 2, followed by passing through the filter 32. A size to satisfy the wavelength selection region 316 of the filter 32 is enough for a luminous flux diameter of such parallel light. It is not necessary to increase the diameter to more than its size. Of the light transmitted through the filter 32, part of the light transmitted through the wavelength selection region 316 other than the cut-away portion 320 is launched into the light-receiving element 4. Of the light transmitted through the filter 32, some or all of the light transmitted through the cut-away portion 320 are launched into the light-receiving element 5. Incidentally, the luminous flux diameter of the parallel light can also be set smaller than the wavelength selection region 316 according to the sizes of light-receiving surfaces of the light-receiving element 4 and the light-receiving element 5.

In a manner similar to the first embodiment, when the wavelength of the light emitted from the semiconductor laser device 1 varies, the amount of the light transmitted through the wavelength selection region 316 varies based on wavelength dependency of the filter 32. Further, the amount of the light received by the light-receiving element 4 varies. Hence the amount of a photocurrent produced in the light-receiving element 4 varies. Thus, the monitoring of the amount of the photocurrent of the light-receiving element 4 enables detection of a variation in wavelength.

When the optical output emitted from the semiconductor laser device 1 varies, the amount of the light transmitted through the cut-away portion 320 and received by the light-receiving element 5 varies and hence the amount of a photocurrent produced in the light-receiving element 5 varies. Thus, the monitoring of the amount of the photocurrent of the light-receiving element 5 enables detection of a variation in optical output. In a manner similar to the first embodiment even in the case of the present embodiment, the temperature is controlled under a thermistor element 7 and a peltier element while monitoring the amounts of the photocurrents from the light-receiving elements 4 and 5, thereby making it possible to control the wavelength of light emitted from the semiconductor laser device 1 and its optical output.

According to the present embodiment as described above, both the wavelength of the light emitted from the semiconductor laser device 1 and its optical output can be controlled by the luminous flux launched into the wavelength selection region 316 owing to the provision of the cut-away portion 320 within the wavelength selection region 316 of the filter 32 in a manner similar to the first embodiment. Thus, since the wavelength selection region 316 may be satisfied even if the diameter of the parallel luminous flux outputted via the lens 2 is of the maximum, the diameter of the parallel luminous flux can be reduced as compared with the conventional one. It is thus possible to reduce a mounting space to a large extent and construct the module in compact form.

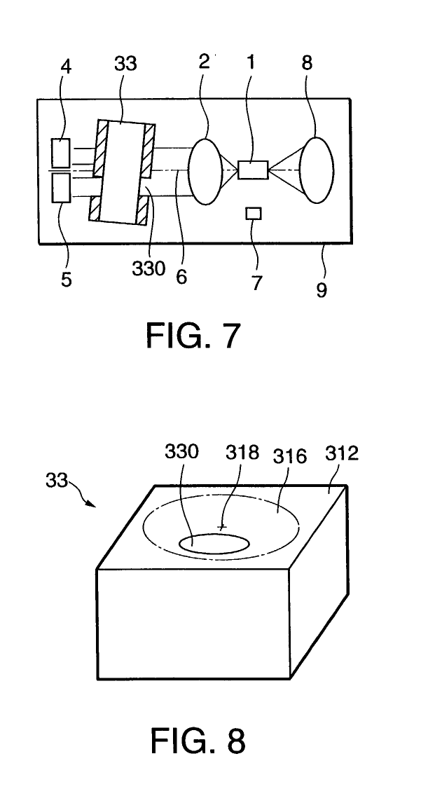

FIG. 7 is a fragmentary configurational view showing a semiconductor laser module according to a third embodiment of the present invention. In the present embodiment, a filter 33 having non-film formed portions 330 is used as an alternative to the filter 31 employed in the first embodiment. Since other elements of structure are similar to those employed in the first embodiment, the description of certain common elements will partly be omitted. Only principal constituent parts on a sub-board 9 are illustrated in FIG. 7, and a package 11, an isolator 12 and an optical fiber 13 are not shown in the drawing.

FIG. 8 shows a schematic configuration of the filter 33. The filter 33 comprises an etalon element and has a non-film formed portion 330. Further, the filter 33 has a predetermined wavelength selectivity and varies in transmittance depending on the wavelength of incident light. The filter 33 has an upper surface 312 shown in FIG. 8 and a lower surface corresponding to a surface opposite thereto, as a light-incoming surface and a light-outgoing surface. A dielectric multilayer film for causing the filter 33 to have the predetermined wavelength selectivity is grown on regions excluding the non-film formed portion 330, of such two surfaces. However, a peripheral portion of the filter 33 has no wavelength selective function due to damage produced during a manufacturing process even if the film is grown thereon. In FIG. 8, a region having a predetermined wavelength selective function is shown on the upper surface of the filter 33 as a wavelength selection region 316. The non-film formed portion 330 is not formed with the dielectric multilayer film for holding the predetermined wavelength selectivity. The non-film formed portion 330 is placed inside the wavelength selection region 316 on the upper surface 312 such that its outer periphery takes the wavelength selection region 316. A similar non-film formed portion 330 is provided even at a position opposite to the non-film formed portion 330 of the upper surface 312 at the top of the lower surface.

As shown in FIG. 7, the lens 8, the isolator 12 and the optical fiber 13 are disposed in turn ahead of a semiconductor laser device 1 along an optical axis 6. The lens 2, filter 33, light-receiving element 4 and light-receiving element 5 are placed at the rear of the semiconductor laser device 1. The filter 33 is disposed with being slightly inclined to the optical axis 6 in such a manner that light reflected from the surface of the filter 33 is not launched into the semiconductor laser device 1. In order to aid the understanding of the filter 33 shown in FIG. 7, portions on which the dielectric multilayer films of the upper surface 312 and the lower surface are deposited, are diagonally shaded. The light-receiving element 4 and the light-receiving element 5 are disposed in parallel within a plane orthogonal to the optical axis 6 such that the optical axis 6 is located therebetween. Now the light-receiving element 4 is disposed in such a manner that light transmitted through the wavelength selection region 316 other than the non-film formed portions 330 of the filter 33 is launched therein. Further, the light-receiving element 5 is placed such that light transmitted through the non-film formed portions 330 of the filter 33 is launched therein.

The light radiated backward from the semiconductor laser device 1 with a spread angle is converted into parallel light by the lens 2, followed by passing through the filter 33. A size to satisfy the wavelength selection region 316 of the filter 33 is enough for a luminous flux diameter of such parallel light. It is not necessary to increase the diameter to more than its size. Of the light transmitted through the filter 33, part of the light transmitted through the wavelength selection region 316 other than the non-film formed portions 330 is launched into the light-receiving element 4. Of the light transmitted through the filter 33, some or all of the light transmitted through the non-film formed portions 330 are launched into the light-receiving element 5. Incidentally, the luminous flux diameter of the parallel light can also be set smaller than the wavelength selection region 316 according to the sizes of light-receiving surfaces of the light-receiving element 4 and the light-receiving element 5.

In a manner similar to the first embodiment, when the wavelength of the light emitted from the semiconductor laser device 1 varies, the amount of the light transmitted through the wavelength selection region 316 varies based on wavelength dependency of the filter 33, and the amount of the light received by the light-receiving element 4 varies. Hence the amount of a photocurrent produced in the light-receiving element 4 varies. Thus, the monitoring of the amount of the photocurrent of the light-receiving element 4 enables detection of a variation in wavelength.

When the optical output emitted from the semiconductor laser device 1 varies, the amount of the light transmitted through the non-film formed portions 330 and received by the light-receiving element 5 varies, and hence the amount of a photocurrent produced in the light-receiving element 5 varies. Thus, the monitoring of the amount of the photocurrent of the light-receiving element 5 enables detection of a variation in optical output. In a manner similar to the first embodiment even in the case of the present embodiment, the temperature is controlled under a thermistor element 7 and a peltier element while monitoring the amounts of the photocurrents from the light-receiving elements 4 and 5, thereby making it possible to control the wavelength of the light emitted from the semiconductor laser device 1 and its optical output.

According to the present embodiment as described above, both the wavelength of the light emitted from the semiconductor laser device 1 and its optical output can be controlled by the luminous flux launched into the wavelength selection region 316 owing to the provision of each non-film formed portion 330 within the wavelength selection region 316 of the filter 33 in a manner similar to the first embodiment. Thus, since the wavelength selection region 316 may be satisfied even if the diameter of the parallel luminous flux outputted via the lens 2 is of the maximum, the diameter of the parallel luminous flux can be reduced as compared with the conventional one. It is thus possible to greatly reduce a mounting space and construct the module in compact form.

Incidentally, an antireflection film may be formed on the non-film formed portion 330 in the third embodiment. Consequently, the amount of the light transmitted through each non-film formed portion 330 and incident to the light-receiving element 5 increases and hence the sensitivity of detection of a variation in optical output can be enhanced. Alternatively, a dielectric multilayer film having a wavelength selective function and an antireflection function may be formed as a dielectric multilayer film. Thus, the amount of light transmitted through the wavelength selection region of the filter 33 and launched into the light-receiving element 4 increases and hence the sensitivity of detection of a variation in wavelength can be enhanced.

While the preferred embodiments according to the present invention have been described above with reference to the accompanying drawings, it is needless to say that the invention is not limited to the embodiments. It will be apparent to those skilled in the art that various changes and modifications can be supposed to be made to the invention within the scope of a technical idea described in the following claims. It is understood that those modifications and changes fall within the technical scope of the invention.

In the first and second embodiments, the through hole 310 and the cut-away portion 320 can be formed by mechanical processing or chemical processing. Upon fabrication of the filters 31 and 32, the dielectric multilayer film may preferably be formed on the light-incoming surface and the light-outgoing surface after the through hole 310 and the cut-away portion 320 have respectively been defined therein. This is because when the dielectric multilayer film is formed in advance, there is a possibility that damage will occur in the dielectric multilayer film upon fabrication of the through hole 310 and the cut-away portion 320. Even when the dielectric multilayer film is formed on wall surfaces of the through hole 310 and the cut-away portion 320 in reverse, this does not influence a basic function. Further, the shapes of the through hole 310 and the cutaway portion 320 are not necessarily limited to the above examples.

What is claimed is:

1. A semiconductor laser module, comprising:
a semiconductor laser device;
a filter including,
a wavelength selection region into which laser light emitted from said semiconductor laser device is launched and having a predetermined wavelength selectivity; and
a through hole provided within said wavelength selection region and through which part of the laser light passes;
a first light-receiving element for receiving the light transmitted through said wavelength selection region other than said through hole; and
a second light-receiving element for receiving the light transmitted through said through hole.

2. A semiconductor laser module, comprising:
a semiconductor laser device;
a filter including,
a wavelength selection region into which laser light emitted from said semiconductor laser device is launched and having a predetermined wavelength selectivity; and
a cut-away portion having at least part thereof provided within said wavelength selection region, and a portion extending from a light-incoming surface to a light-outgoing surface, said portion being cut such that part of the laser light is capable of passing therethrough;
a first light-receiving element for receiving the light transmitted through said wavelength selection region other than said cut-away portion; and
a second light-receiving element for receiving the light transmitted through said cut-away portion.

3. A semiconductor laser module, comprising:
a semiconductor laser device;
a filter including,
a wavelength selection region into which laser light emitted from said semiconductor laser device is launched, and having a predetermined wavelength selectivity, said wavelength selection region including a film formed on the surface thereof, for causing said wavelength selection region to have the predetermined wavelength selectivity; and
a non-film formed portion having said wavelength selection region as an outer periphery and free of the formation of the film;
a first light-receiving element for receiving the light transmitted through said wavelength selection region; and
a second light-receiving element for receiving the light transmitted through said non-film formed portion.

4. The semiconductor laser module according to claim 3, wherein said non-film formed portion is formed with an antireflection film.

5. The semiconductor laser module according to claim 3, wherein the film further includes an antireflection function.
